(19) United States
(12) Patent Application Publication
(10) Pub. No.: US 2026/0156097 A1
(43) Pub. Date: Jun. 4, 2026

(54) DOMAIN CONTROL PLANE SYSTEM AND METHOD

(71) Applicant: DNSimple Corporation, Melbourne, FL (US)

(72) Inventors: Anthony Eden, Malabar, FL (US); Simone Carletti, Rome (IT)

(21) Appl. No.: 18/964,991

(22) Filed: Dec. 2, 2024

(51) Int. Cl. H04L 61/4511; G06F 21/64

(52) U.S. Cl. CPC H04L 61/4511; G06F 21/64

(57) ABSTRACT

A system includes a memory storing computer-readable instructions and at least one processor to receive provider information for at least one domain name service (DNS) provider, transmit an encrypted representation of the provider information to at least one server computing device associated with the at least one DNS provider, store the encrypted representation of the provider information in a database, select at least one zone associated with the at least one DNS provider, import information associated with the at least one zone associated with the at least one DNS provider and receive a request to one of add a DNS record, update a DNS record, and remove a DNS record, and transmit the request along with the encrypted representation of the provider information to the server computing device associated with the at least one DNS provider to perform the request with the at least one DNS provider.

### BACKGROUND

According to ICANN, there are approximately 2815 accredited registrars. In addition, according to Verisign, there are currently 359.3 million domain name registrations and the domain industry continues to grow each year. As an example, the third quarter of 2023 closed with 359.3 million domain name registrations across all top-level domains (TLDs), an increase of 2.7 million domain name registrations, or 0.8%, compared to the second quarter of 2023. Domain name registrations have increased by 8.5 million or 2.4% year over year. The . com and . net top level domains had a combined total of 173.9 million domain name registrations in the domain name database at the end of the third quarter of 2023.

Domain registrations are often distributed across a large number of TLDs. As of December 2023, according to the IANA root database there are more than 1500 available TLDs, each of them with their own policies that often require to register a domain with a different registrar. The increase in domain registration is driving customer demand for better ways to organize and track wide portfolios.

It is with these issues in mind, among others, that various aspects of the disclosure were conceived.

### SUMMARY

The present disclosure is directed to a domain control plane system and method. The system may include one or more client computing devices that communicate with one or more server computing devices to synchronize, manage, and view zones associated with DNS providers using a domain control plane application. A user can link one or more DNS providers and manage DNS settings and zones across multiple platforms using the domain control plane application that provides a graphical user interface (GUI). The user can use the domain control plane application to add one or more DNS providers and receive a request to one of add a DNS record, update a DNS record, and remove a DNS record and transmit the request along with the encrypted representation of the provider information to the server computing devices associated with the at least one DNS provider to perform the request with the at least one DNS provider.

In one example, a system may include a memory storing computer-readable instructions and at least one processor to execute the instructions to receive provider information for at least one domain name service (DNS) provider, transmit an encrypted representation of the provider information to at least one server computing device associated with the at least one DNS provider, store the encrypted representation of the provider information in a database, select at least one zone associated with the at least one DNS provider, import information associated with the at least one zone associated with the at least one DNS provider, and receive a request to one of add a DNS record, update a DNS record, and remove a DNS record, and synchronize the request by transmitting the request along with the encrypted representation of the provider information to the server computing device associated with the at least one DNS provider to perform the request with the at least one DNS provider.

In another example, a method may include transmitting, by at least one processor, an encrypted representation of the provider information to at least one server computing device associated with the at least one DNS provider, storing, by the at least one processor, the encrypted representation of the provider information in a database, selecting, by the at least one processor, at least one zone associated with the at least one DNS provider, importing, by the at least one processor, information associated with the at least one zone associated with the at least one DNS provider, and receiving, by the at least one processor, a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.

In another example, a non-transitory computer-readable storage medium may have instructions stored thereon that, when executed by a computing device cause the computing device to perform operations, the operations including transmitting an encrypted representation of the provider information to at least one server computing device associated with the at least one DNS provider, storing the encrypted representation of the provider information in a database, selecting at least one zone associated with the at least one DNS provider, importing information associated with the at least one zone associated with the at least one DNS provider, and receiving a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a domain control plane system according to an example of the instant disclosure.

FIG. 2 is a flow diagram associated with linking an external provider according to an example of the instant disclosure.

FIG. 3 is a flow diagram associated with adding a DNS record according to an example of the instant disclosure.

FIG. 4 is a flow diagram associated with updating a DNS record according to an example of the instant disclosure.

FIG. 5 is a flow diagram associated with removing a DNS record according to an example of the instant disclosure.

FIG. 6 is a flow diagram associated with unlinking an external provider according to an example of the instant disclosure.

FIG. 7 is a flow diagram associated with receiving provider information for at least one DNS provider and displaying information associated with the at least one DNS provider according to an example of the instant disclosure.

FIG. 8 is a screenshot of a domain control plane application according to an example of the instant disclosure.

FIG. 9 is another screenshot of the domain control plane application according to an example of the instant disclosure.

FIG. 10 is another screenshot of the domain control plane application according to an example of the instant disclosure.

FIG. 11 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The domain control plane system may include an interface and application programming interface (API) for registering and managing domain names and their authoritative DNS zones across multiple domain registrars and authoritative DNS providers. Conventionally, system administrators and information technology professionals have to log into and manage domain names and DNS zones across a variety of service providers. Each provider's user interface is different, resulting in a significant burden on the user. Furthermore, many providers have no API for managing domains and DNS zones using third-party software. The domain control plane system solves this problem by providing a unified and consistent interface as well as a single unified API layer so that users may access all of their domains and DNS zones through a common interface.

The domain control plane system includes a software application operating on a collection of web servers with a common data storage system that connects both synchronously and asynchronously to integrated domain registrars and DNS hosting services to provide users access to their domains and DNS zones through a web interface and/or REST API. Changes to domain name states and DNS zone states may occur either within the software application and may be transmitted to the appropriate provider, or may occur within the provider and then may be synchronized to the domain control plane data storage system. Integrations for additional providers may be added or removed in the future. Customers may activate providers that they wish to use by providing security credentials such as API keys, usernames and passwords, certificates, or other credentials which are then securely stored in the software's data storage system.

Customers can also selectively enable which domains or DNS zones they want to operate via the domain control plane system at each provider, enabling maximum flexibility to manage multiple accounts or shared accounts without conflicts.

In one example, the system can handle both domain name registrations and operational aspects such as authoritative DNS aspects of domain management across a collection of providers.

According to ICANN, there are approximately 2815 accredited registrars. In addition, according to Verisign, there are currently 359.3 million domain name registrations and the domain industry continues to grow each year. As an example, the third quarter of 2023 closed with 359.3 million domain name registrations across all top-level domains (TLDs), an increase of 2.7 million domain name registrations, or 0.8%, compared to the second quarter of 2023. Domain name registrations have increased by 8.5 million or 2.4% year over year. The .com and .net top level domains had a combined total of 173.9 million domain name registrations in the domain name database at the end of the third quarter of 2023.

Domain registrations are often distributed across a large number of TLDs. As of December 2023, according to the IANA root database there are more than 1500 available TLDs, each of them with their own policies that often require to register a domain with a different registrar. The increase in domain registration is driving customer demand for better ways to organize and track wide portfolios.

Moreover, the increase of domain registrations is accompanied by an increase of DNS traffic. This is immediately evident by the DNS Query Trend report by Verisign, that shows the impressive year-over-year growth at both root and TLD level.

It is desirable to have secure, reliable, and programmatic access to domain registrars and authoritative DNS provider data.

Companies in the space do not expose a public API that facilitates the interaction with the data stored in their system from third party software. These companies usually assume that the customers of their product would interact manually through their web interface/portal.

The lack of a public API that can be accessed programmatically increases the complexity required to write and execute automated processes that can be performed without human manual interaction.

A user may use a domain control plane application by providing credentials for accessing the external DNS or domain provider. Credentials may be access tokens, user credentials, negotiated transactional tokens, or other authentication mechanisms. The credentials can be encrypted and stored in a database table connected to the domain control plane application. A connection is established to the external provider and a list of the available zones or domains is retrieved. The user may select the domains they want to control from within the domain control plane and metadata associated with each of those connected zones or domains is stored in the database.

Once one or more zones are connected, DNS records can be synchronized between the control plane application and external provider either automatically by the domain control plane based on predefined triggers, or by the user by triggering a synchronization to or from the external provider.

As an example, the user can trigger a synchronization by selecting a user interface element that allows the user to “Synchronize DNS records”. When the user interface element is selected, the user can select the source and destination of the operation. Once selected, it is possible to make an API request to the external zone provider for the current zone records and then, if the external provider is the set destination, update the external zone's records. The response can be a listing of the zone's records and/or record sets.

When a record for a zone is created, updated, or deleted, the operation may also be applied to any linked external providers.

When a user removes an external provider from the collection of linked providers in their account, any synchronized zones may be optionally removed from the external provider. The metadata for each zone, along with the external provider credentials, are removed from the domain control plane database.

In one example, the domain control plane system provides an external DNS hosting service that supports the ability to synchronize, manage, and view zones that are deployed in DNS providers. Integrated DNS providers can be linked with an account to allow a user to manage DNS settings and zones across multiple platforms using a single user interface. This may allow a user that has domains registered or managed on multiple platforms to use a single user interface. As a result, the system provides centralized DNS management for domains, regardless of where they are registered. In addition, the system provides seamless access to advanced DNS features for domains hosted on multiple platforms. Additionally, the system provides a simplified migration process.

When a user connects a DNS provider to the system and connects an associated account, a user can select a zone hosted on an integrated DNS provider that is to be imported into the system. In addition, a user may add and delete zones from a DNS provider. A user can also remove an integrated zone. Additionally, a user can manage integrated zone records by performing list, create, update, and delete integrated zone records using the system. A user also may sync zone records from an integrated zone to the system or from the system to an integrated zone.

As an example, the system may connect one or more integrated DNS providers to the account including Amazon Route 53, Azure DNS, and CoreDNS, among others. As a result, supported record types from an integrated DNS provider can be synched with the system.

In one example, a user may connect one or more integrated DNS providers to an account such as Azure, Cloudflare, CoreDNS, Gandi, GoDaddy, Google Domains, Route53, and others. In one example, a user could connect to Route53 by providing a nickname for an account, an access key ID, and a secret access key. The system may connect to the account using this information and may view a list of zones associated with the provider such as coolwebsite.com, coolerwebsite.com, awesome-webapp.com, and others. If zones are selected to import, they may be imported into the system. Additionally, a user may remove an integrated DNS provider from the account by selecting the provider and removing the provider. As is known, a DNS zone may be a portion of a DNS namespace that is managed by a specific organization or an administrator. A DNS zone may begin at a domain within a hierarchical tree and can extend down into subdomains such that multiple subdomains can be managed by one entity. A DNS zone may include multiple subdomains and multiple zones may exist on a same server.

After connecting an integrated DNS provider, a user may view, add to, or remove imported zones. A user also may add a zone to an integrated DNS provider or may remove integrated zones.

Aspects of an domain control plane system and method includes a client computing device that communicates with one or more server computing devices to send information associated with one or more DNS providers.

A user may utilize the domain control plane system to keep track of registrars for every domain that is managed, access information about every domain's registration and ownership status, obtain operational status information, and view where DNS zones and certificates are deployed. In addition, the domain control plane system provides two-way management and the ability to add, edit, and remove DNS records. In addition, the system allows a user to register, transfer, or renew domain names. The system can provide information such as access information that indicates which users or systems have access to each domain. In addition, a user may request and deploy SSL certificates.

In one example, a system may include a memory storing computer-readable instructions and at least one processor to execute the instructions to receive provider information for at least one domain name service (DNS) provider, transmit an encrypted representation of the provider information to at least one server computing device associated with the at least one DNS provider, store the encrypted representation of the provider information in a database, select at least one zone associated with the at least one DNS provider, import information associated with the at least one zone associated with the at least one DNS provider, and receive a request to one of add a DNS record, update a DNS record, and remove a DNS record, and synchronize the request by transmitting the request along with the encrypted representation of the provider information to the server computing device associated with the at least one DNS provider to perform the request with the at least one DNS provider.

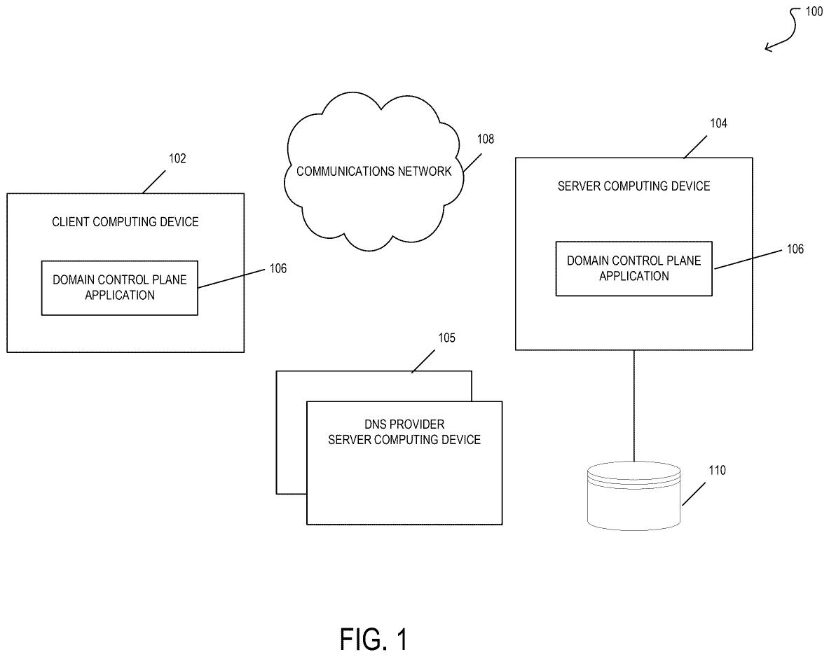

FIG. 1 is a block diagram of a domain control plane system 100 according to an example of the instant disclosure. As shown in FIG. 1, the system 100 may include at least one client computing device 102 and at least one server computing device 104. The at least one server computing device 104 may be in communication with at least one database 110. In addition, the at least one server computing device may be in communication with at least one server computing device associated with at least one DNS provider 105.

The client computing device 102 and the server computing device 104 may have a domain control plane application 106 that may be a component of an application and/or service executable by the at least one client computing device 102 and/or the server computing device 104. For example, the domain control plane application 106 may be a single unit of deployable executable code or a plurality of units of deployable executable code. According to one aspect, the domain control plane application 106 may include one component that may be a web application, a native application, and/or a mobile application (e.g., an app) downloaded from a digital distribution application platform that allows users to browse and download applications developed with mobile software development kits (SDKs) including the App Store and GOOGLE PLAY®, among others.

The domain control plane system 100 also may include a relational database management system (RDBMS), e.g., MySQL, or another type of database management system such as a NoSQL database system that stores and communicates data from at least one database 110. The data stored in the at least one database 110 may be associated with one or more external providers such as credentials associated with the external providers including security credentials for at least one DNS provider. The security credentials may include at least one of API key information, at least one username, at least one password, and at least one certificate, among others. In addition, the data stored in the at least one database 110 may be zone information associated with the at least one DNS provider.

As an example, the security credentials can be encrypted in the database 110 and are decrypted when initiating a network request to the external provider's API on the user's behalf.

When a user first establishes intent to manage third-party assets, the user can send the security credentials, which are encrypted and stored in the database 110. When the user takes an action that requires a change at the external provider, the security credentials are decrypted from the database 110.

When the user desires a change to the external provider, the details are transformed and proxied to the provider's public HTTPS API using the stored security credentials.

For on-premises external providers, a pull mechanism can poll the primary system via its HTTPS API at a regular interval. The external provider fetches the latest zone data and updates its own zone as needed. The latest pull timestamp is stored in the database 110.

The at least one client computing device 102 and the at least one server computing device 104 may be configured to receive data from and/or transmit data through a communication network 108. Although the client computing device 102 and the server computing device 104 are shown as a single computing device, it is contemplated that each computing device may include multiple computing devices or multiple virtual machines, or multiple containers, for example, in a cloud computing configuration.

The communication network 108 can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The client computing device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 102 further includes at least one communications interface to transmit and receive communications, messages, and/or signals.

The client computing device 102 could be a programmable logic controller, a programmable controller, a laptop computer, a smartphone, a personal digital assistant, a tablet computer, a standard personal computer, or another processing device. The client computing device 102 may include a display, such as a computer monitor, for displaying data and/or graphical user interfaces. The client computing device 102 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 104 further includes at least one communications interface to transmit and receive communications, messages, and/or signals.

As an example, the client computing device 102 and the server computing device 104 communicate data in packets, messages, or other communications using a common protocol, e.g., Hypertext Transfer Protocol (HTTP) and/or Hypertext Transfer Protocol Secure (HTTPS). The one or more computing devices may communicate based on representational state transfer (REST) and/or Simple Object Access Protocol (SOAP). As an example, a first computer (e.g., the client computing device 102) may send a request message that is a REST and/or a SOAP request formatted using JavaScript Object Notation (JSON) and/or Extensible Markup Language (XML). In response to the request message, a second computer (e.g., the server computing device 104) may transmit a REST and/or SOAP response formatted using JSON and/or XML.

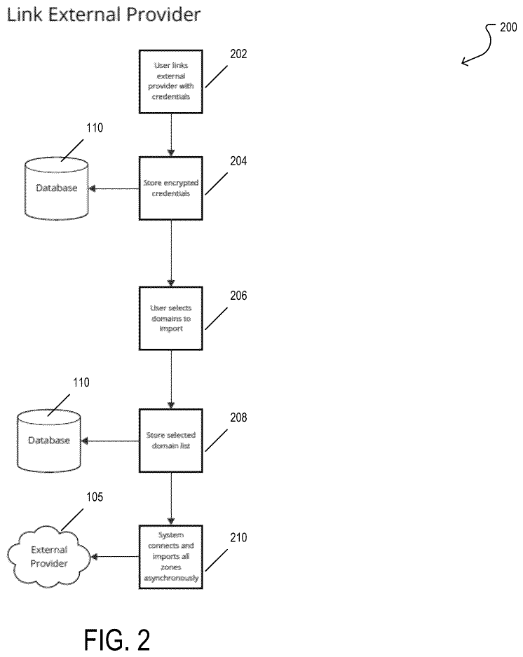

FIG. 2 shows a flow diagram 200 associated with linking an external provider according to an example of the instant disclosure. As shown in FIG. 2, in block 202, a user may link an external provider with credentials by providing credentials associated with the external provider. Next, in block 204, the system 100 may store an encrypted representation of the credentials in the database 110. Next, in block 206, a user may select one or more domains to import. The one or more domains may be associated with the external provider. In block 208, the system may store a selected domain list in the database 110. Next, in block 210, the system 100 may connect and import zones associated with the domains asynchronously.

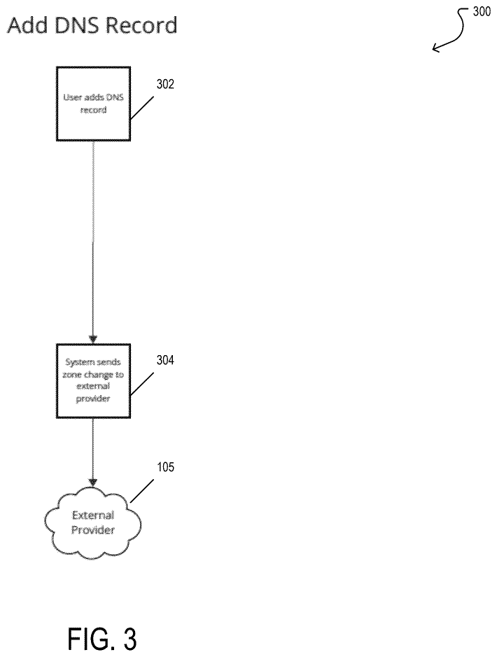

FIG. 3 shows a flow diagram 300 associated with adding a DNS record according to an example of the instant disclosure. As shown in FIG. 3, in block 302, a user may add one or more DNS records at the domain control plane application 106. In block 304, the system 100 may synchronize and send one or more zone changes to an external provider.

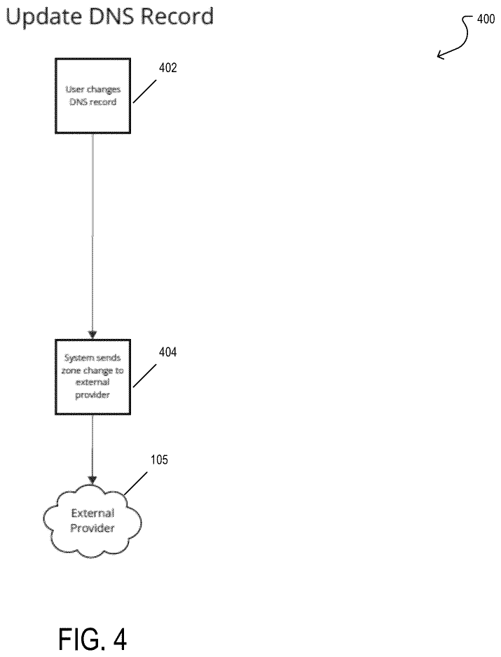

FIG. 4 shows a flow diagram 400 associated with updating a DNS record according to an example of the instant disclosure. As shown in FIG. 4, at block 402, a user may change one or more DNS records at the domain control plane application 106. In block 404, the system 100 may synchronize and send one or more zone changes to an external provider.

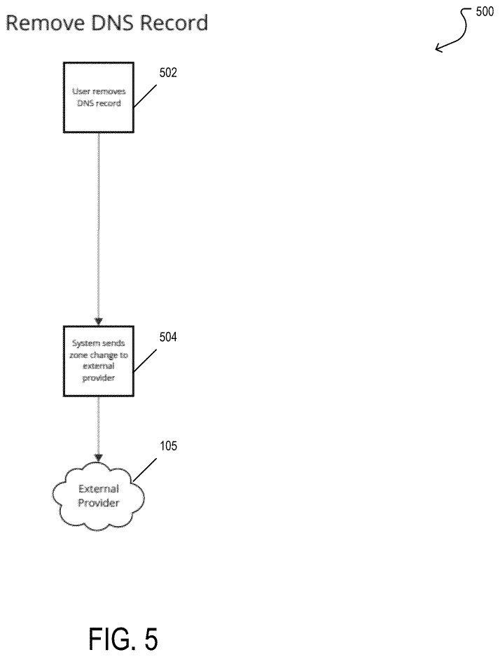

FIG. 5 shows a flow diagram 500 associated with removing a DNS record according to an example of the instant disclosure. As shown in FIG. 5, at block 502, a user may remove one or more DNS records at the domain control plane application 106. Next, at block 504, the system 100 may synchronize and send one or more zone changes to an external provider.

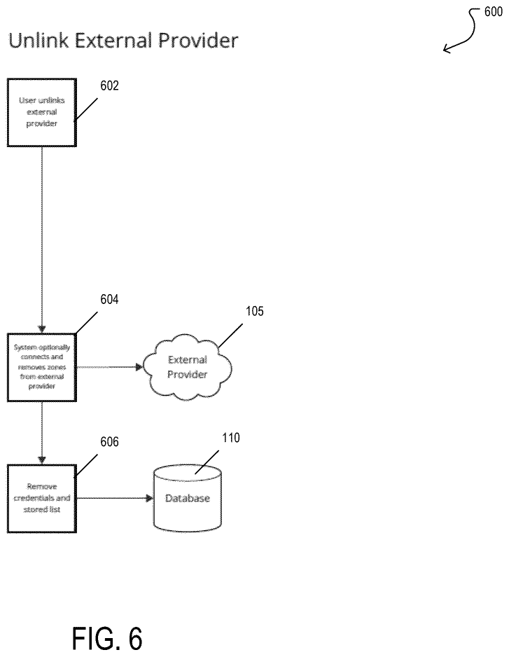

FIG. 6 shows a flow diagram 600 associated with unlinking an external provider according to an example of the instant disclosure. As shown in FIG. 6, at block 602, a user may unlink an external provider. Next, at block 604, the system 100 may optionally connect and remove zones from the external provider. Next, at block 606, the system may remove credentials and a stored list from the database 110.

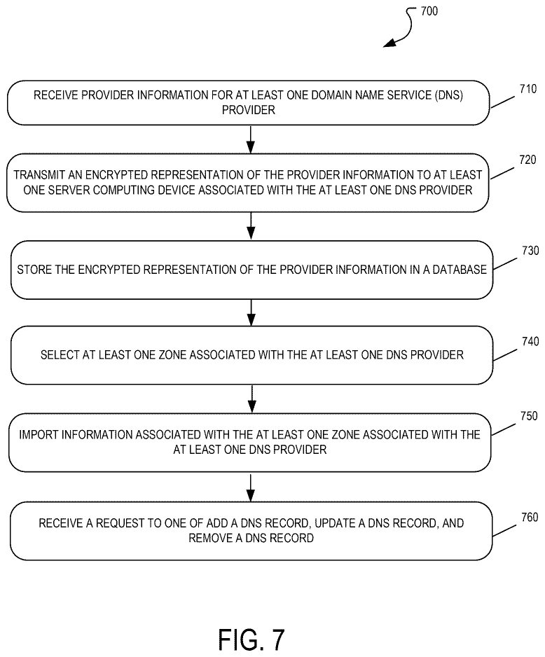

FIG. 7 illustrates an example method 700 of receiving provider information for at least one DNS provider and displaying information associated with the at least one DNS provider according to an example of the instant disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method 700 may include receiving provider information for at least one domain name service (DNS) provider at block 710.

Next, according to some examples, the method 700 may include transmitting an encrypted representation of the provider information to at least one server computing device associated with the at least one DNS provider 105 at block 720.

Next, according to some examples, the method 700 may include storing the encrypted representation of the provider information in the database 110 at block 730.

Next, according to some examples, the method 700 may include selecting at least one zone associated with the at least one DNS provider at block 740.

Next, according to some examples, the method 700 may include importing information associated with the at least one zone associated with the at least one DNS provider into the domain control plane application 106 at block 750.

Next, according to some examples, the method 700 may include receiving a request to one of add a DNS record, update a DNS record, and remove a DNS record and performing the request in the domain control plane application 106 and synchronizing the request by transmitting the request along with the encrypted representation of the provider information to the server computing device associated with the at least one DNS provider 105 to perform the request with the at least one DNS provider at block 760.

In some examples, the method 700 may include adding the DNS record and sending a zone change to the at least one server computing device associated with the at least one DNS provider 105.

In some examples, the method 700 may include updating the DNS record and sending a zone change to the at least one server computing device associated with the at least one DNS provider 105.

In some examples, the method 700 may include removing the DNS record and sending a zone change to the at least one server computing device associated with the at least one DNS provider 105.

In some examples, the method 700 may include receiving a request to unlink at least one DNS provider, removing zones associated with the at least one DNS provider, and deleting the encrypted representation of the provider information from the database 110.

In some examples, the method 700 may include receiving the provider information for the at least one DNS provider via a REST application programming interface (API).

In some examples, the method 700 may include storing security credentials for the at least one DNS provider in the database, the security credentials comprising at least one of API key information, at least one username, at least one password, and at least one certificate.

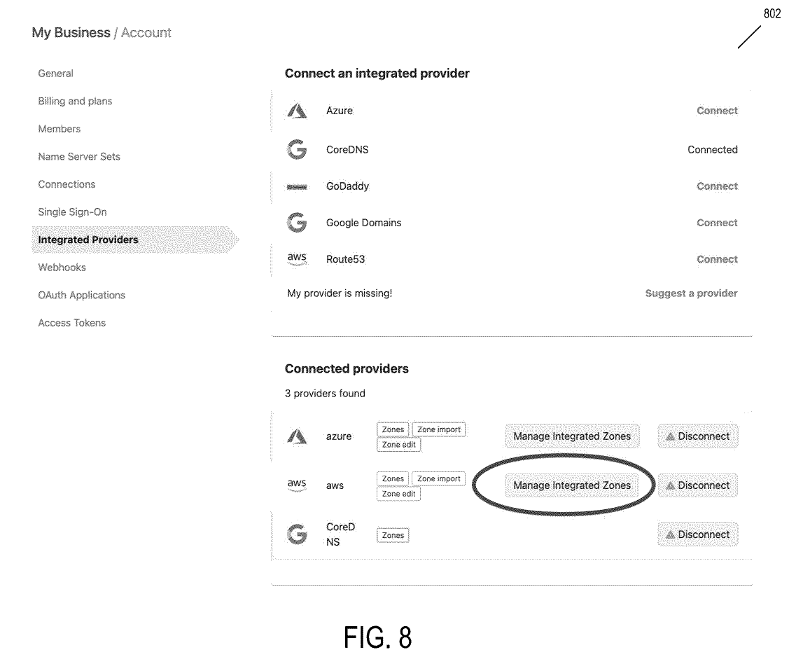

FIG. 8 is a screenshot 802 of the domain control plane application 106 according to an example of the instant disclosure. As shown in FIG. 8, a user may connect one or more providers such as Azure, CoreDNS, GoDaddy, Google Domains, and Route53, among others. In this example, there are multiple connected providers and a user may view and/or modify information associated with each provider by selecting user interface elements such as Zones, Zone import, Zone edit, Manage Integrated Zones, and Disconnect.

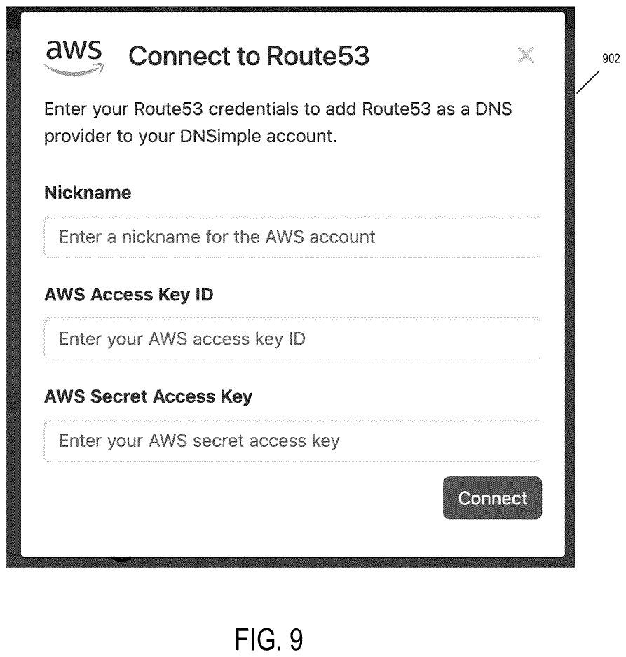

FIG. 9 is another screenshot 902 of the domain control plane application 106 according to an example of the instant disclosure. As shown in FIG. 9, a user may connect to Route53 by providing credential information to add Route53 as a DNS provider. In one example, a user may provide a nickname, an AWS access key ID, and an AWS secret access key and select a user interface element such as the “Connect” button.

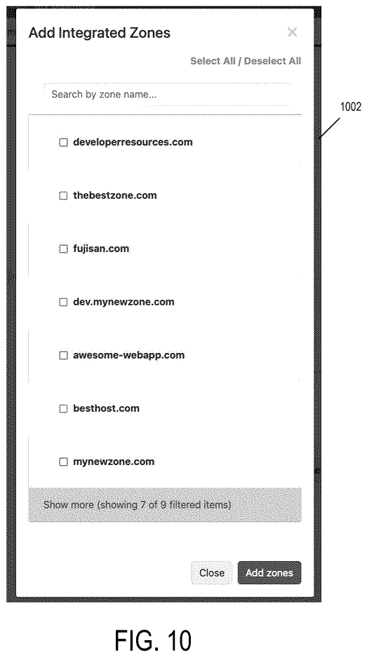

FIG. 10 is another screenshot 1002 of the domain control plane application 106 according to an example of the instant disclosure. As shown in FIG. 10, the user may select one or more zones associated with a provider to add the zones. In one example, the user may select all of the zones or deselect all of the zones. In one example, the zones may be developerresources.com, thebestzone.com, fujisan.com, dev.mynewzone.com, awesome-webapp.com, besthost.com, and mynewzone.com, among others. The user may add the zones by selecting a user interface element such as an “Add zones” button.

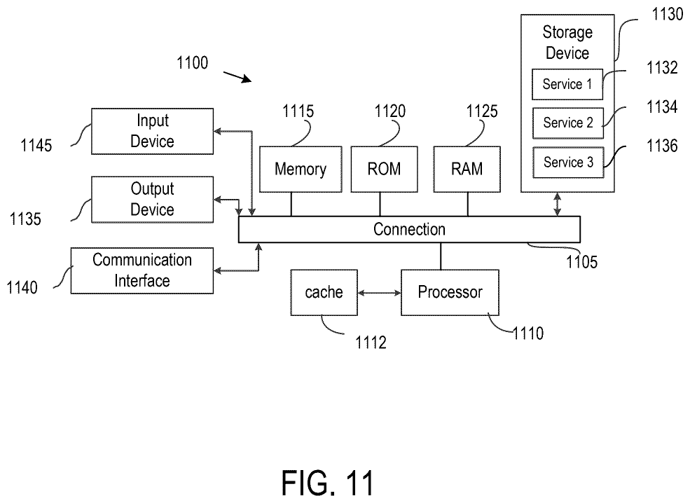

FIG. 11 shows an example of computing system 1100, which can be for example any computing device making up the computing device such as the client computing device 102, the server computing device 104, the server computing device associated with at least one DNS provider 105, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. There is no restriction on operating on any particular hardware arrangement, and therefore the basic features here may easily be substituted for improved hardware or firmware arrangements as they are developed.

Storage device 1130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:
Aspect 1: A system comprising: a memory storing computer-readable instructions; and at least one processor to execute the instructions to receive provider information for at least one domain name service (DNS) provider, transmit an encrypted representation of the provider information to at least one server computing device associated with the at least one DNS provider,

store the encrypted representation of the provider information in a database, select at least one zone associated with the at least one DNS provider, import information associated with the at least one zone associated with the at least one DNS provider, and receive a request to one of add a DNS record, update a DNS record, and remove a DNS record, and synchronize the request by transmitting the request along with the encrypted representation of the provider information to the server computing device associated with the at least one DNS provider to perform the request with the at least one DNS provider.
Aspect 2: The system of Aspect 1, the at least one processor further to add the DNS record and send a zone change to the at least one server computing device associated with the at least one DNS provider.
Aspect 3: The system of Aspects 1 and 2, the at least one processor further to update the DNS record and send a zone change to the at least one server computing device associated with the at least one DNS provider.
Aspect 4: The system of Aspects 1 to 3, the at least one processor further to remove the DNS record and send a zone change to the at least one server computing device associated with the at least one DNS provider.
Aspect 5: The system of Aspects 1 to 4, the at least one processor further to receive a request to unlink at least one DNS provider, remove zones associated with the at least one DNS provider, and delete the encrypted representation of the provider information from the database.
Aspect 6: The system of Aspects 1 to 5, the at least one processor further to receive the provider information for the at least one DNS provider via a REST application programming interface (API).
Aspect 7: The system of Aspects 1 to 6, the at least one processor further to store security credentials for the at least one DNS provider in the database, the security credentials comprising at least one of API key information, at least one username, at least one password, and at least one certificate.
Aspect 8: A method comprising transmitting, by at least one processor, an encrypted representation of the provider information to at least one server computing device associated with the at least one DNS provider, storing, by the at least one processor, the encrypted representation of the provider information in a database, selecting, by the at least one processor, at least one zone associated with the at least one DNS provider, importing, by the at least one processor, information associated with the at least one zone associated with the at least one DNS provider, and receiving, by the at least one processor, a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.
Aspect 9: The method of Aspect 8, further comprising adding the DNS record and sending a zone change to the at least one server computing device associated with the at least one DNS provider.
Aspect 10: The method of Aspects 8 and 9, further comprising updating the DNS record and sending a zone change to the at least one server computing device associated with the at least one DNS provider.
Aspect 11: The method of Aspects 8 to 10, further comprising removing the DNS record and sending a zone change to the at least one server computing device associated with the at least one DNS provider.
Aspect 12: The method of Aspects 8 to 11, further comprising receiving a request to unlink at least one DNS provider, removing zones associated with the at least one DNS provider, and deleting the encrypted representation of the provider information from the database.
Aspect 13: The method of Aspects 8 to 12, further comprising receiving the provider information for the at least one DNS provider via a REST application programming interface (API).
Aspect 14: The method of Aspects 8 to 13, further comprising storing security credentials for the at least one DNS provider in the database, the security credentials comprising at least one of API key information, at least one username, at least one password, and at least one certificate.
Aspect 15: A non-transitory computer-readable storage medium, having instructions stored thereon that, when executed by a computing device cause the computing device to perform operations, the operations comprising transmitting an encrypted representation of the provider information to at least one server computing device associated with the at least one DNS provider, storing the encrypted representation of the provider information in a database, selecting at least one zone associated with the at least one DNS provider, importing information associated with the at least one zone associated with the at least one DNS provider, and receiving a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.
Aspect 16: The non-transitory computer-readable storage medium of Aspect 15, the operations further comprising adding the DNS record and sending a zone change to the at least one server computing device associated with the at least one DNS provider.
Aspect 17: The non-transitory computer-readable storage medium of Aspects 15 and 16, the operations further comprising updating the DNS record and sending a zone change to the at least one server computing device associated with the at least one DNS provider.
Aspect 18: The non-transitory computer-readable storage medium of Aspects 15 to 17, the operations further comprising removing the DNS record and sending a zone change to the at least one server computing device associated with the at least one DNS provider.
Aspect 19: The non-transitory computer-readable storage medium of Aspects 15 to 18, the operations further comprising receiving a request to unlink at least one DNS provider, removing zones associated with the at least one DNS provider, and deleting the encrypted representation of the provider information from the database.
Aspect 20: The non-transitory computer-readable storage medium of Aspects 15 to 19, the operations further comprising receiving the provider information for the at least one DNS provider via a REST application programming interface (API).
Aspect 21: The non-transitory computer-readable storage medium of Aspects 15 to 20, the operations further comprising storing security credentials for the at least one DNS provider in the database, the security credentials comprising at least one of API key information, at least one username, at least one password, and at least one certificate.

What is claimed is:

1. A system comprising:
a memory storing computer-readable instructions; and
at least one processor to execute the instructions to:
receive provider information for at least one domain name service (DNS) provider;
transmit an encrypted representation of the provider information to at least one server computing device associated with the at least one DNS provider;
store the encrypted representation of the provider information in a database;
select at least one zone associated with the at least one DNS provider;
import information associated with the at least one zone associated with the at least one DNS provider; and
receive a request to one of add a DNS record, update a DNS record, and remove a DNS record, and synchronize the request by transmitting the request along with the encrypted representation of the provider information to the server computing device associated with the at least one DNS provider to perform the request with the at least one DNS provider.

2. The system of claim 1, the at least one processor further to add the DNS record and send a zone change to the at least one server computing device associated with the at least one DNS provider.

3. The system of claim 1, the at least one processor further to update the DNS record and send a zone change to the at least one server computing device associated with the at least one DNS provider.

4. The system of claim 1, the at least one processor further to remove the DNS record and send a zone change to the at least one server computing device associated with the at least one DNS provider.

5. The system of claim 1, the at least one processor further to receive a request to unlink at least one DNS provider, remove zones associated with the at least one DNS provider, and delete the encrypted representation of the provider information from the database.

6. The system of claim 1, the at least one processor further to receive the provider information for the at least one DNS provider via a REST application programming interface (API).

7. The system of claim 1, the at least one processor further to store security credentials for the at least one DNS provider in the database, the security credentials comprising at least one of API key information, at least one username, at least one password, and at least one certificate.

8. A method, comprising:
transmitting, by at least one processor, an encrypted representation of the provider information to at least one server computing device associated with the at least one DNS provider;
storing, by the at least one processor, the encrypted representation of the provider information in a database;
selecting, by the at least one processor, at least one zone associated with the at least one DNS provider;
importing, by the at least one processor, information associated with the at least one zone associated with the at least one DNS provider; and
receiving, by the at least one processor, a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.

9. The method of claim 8, further comprising adding the DNS record and sending a zone change to the at least one server computing device associated with the at least one DNS provider.

10. The method of claim 8, further comprising updating the DNS record and sending a zone change to the at least one server computing device associated with the at least one DNS provider.

11. The method of claim 8, further comprising removing the DNS record and sending a zone change to the at least one server computing device associated with the at least one DNS provider.

12. The method of claim 8, further comprising receiving a request to unlink at least one DNS provider, removing zones associated with the at least one DNS provider, and deleting the encrypted representation of the provider information from the database.

13. The method of claim 8, further comprising receiving the provider information for the at least one DNS provider via a REST application programming interface (API).

14. The method of claim 8, further comprising storing security credentials for the at least one DNS provider in the database, the security credentials comprising at least one of API key information, at least one username, at least one password, and at least one certificate.

15. A non-transitory computer-readable storage medium, having instructions stored thereon that, when executed by a computing device cause the computing device to perform operations, the operations comprising:
transmitting an encrypted representation of the provider information to at least one server computing device associated with the at least one DNS provider;
storing the encrypted representation of the provider information in a database;
selecting at least one zone associated with the at least one DNS provider;
importing information associated with the at least one zone associated with the at least one DNS provider; and
receiving a request to one of add a DNS record, update a DNS record, and remove a DNS record, and synchronizing the request by transmitting the request along with the encrypted representation of the provider information to the server computing device associated with the at least one DNS provider to perform the request with the at least one DNS provider.

16. The non-transitory computer-readable medium of claim 15, the operations further comprising adding the DNS record and sending a zone change to the at least one server computing device associated with the at least one DNS provider.

17. The non-transitory computer-readable medium of claim 15, the operations further comprising updating the DNS record and sending a zone change to the at least one server computing device associated with the at least one DNS provider.

18. The non-transitory computer-readable medium of claim 15, the operations further comprising removing the DNS record and sending a zone change to the at least one server computing device associated with the at least one DNS provider.

19. The non-transitory computer-readable medium of claim 15, the operations further comprising receiving a request to unlink at least one DNS provider, removing zones associated with the at least one DNS provider, and deleting the encrypted representation of the provider information from the database.

20. The non-transitory computer-readable medium of claim 15, the operations further comprising receiving the provider information for the at least one DNS provider via a REST application programming interface (API).

21. The non-transitory computer-readable medium of claim 15, the operations further comprising storing security credentials for the at least one DNS provider in the database, the security credentials comprising at least one of API key information, at least one username, at least one password, and at least one certificate.
